(19) United States
(12) Patent Application Publication
(10) Pub. No.: US 2006/0034378 A1
(43) Pub. Date: Feb. 16, 2006

(54) Papr reduction

(76) Inventors: Jan Lindskog, Pixbo (SE); Roger Walther, Molndal (SE); Sten Sjoberg, Landvetter (SE); Gunnar Rydnell, Frolunda (SE); Goran Kronquist, Grabo (SE)

Correspondence Address: ERICSSON INC., 6300 LEGACY DRIVE, M/S EVR C11, PLANO, TX, 75024, US

(21) Appl. No.: 10/531,794

(22) PCT Filed: Nov. 7, 2002
(86) PCT No.: PCT/SE02/02033

§ 371 Date: Apr. 18, 2005

(51) Int. Cl. H04K 1/10

(52) U.S. Cl. 375/260

(57) ABSTRACT

Method of communicating frames of digital data by OFDM modulated signals comprising a first plurality of payload carrying sub-channels and a second plurality of pilot carrying sub-channels, whereby consecutive frames of payload data is are associated with a given pilot configuration and transmitted. Prior to the transmission of a frame of payload data, each of the plurality of pilot configurations are evaluated with regard to PAPR, whereby the pilot configuration being associated with the lowest PAPR value is being chosen for transmission.

### FIELD OF THE INVENTION

This invention pertains to the area of wireless radio access technology. More particular, the present invention concerns methods and systems using orthogonal frequency division multiplexing (OFDM), such as Wireless LANs (WLAN).

### BACKGROUND OF THE INVENTION

A well-known problem in OFDM modulation is high PAPR (Peek to Average Power Ratio) values. High PAPR values occur since it is not possible to control the power level for each symbol when constructing the OFDM (Orthogonal Frequency Division Multiplex) waveform.

The optimal situation for error free transmission is to have a stable constant PAPR level throughout the transmission of individual packets, in order for the power amplifier (PA) to work well. The PA is typically linear only over a limited range in power level, and thus high fluctuations in PAPR level causes the PA to behave non-linearly. Non-linearity of the PA is devastating for the Bit error rate (BER)/Packet error rate (PER) of QAM (Quadrature Amplitude Modulation)-signalling.

There are well known solutions to the classical problem of excessively high PAPR levels, namely to re-code the data, re-scramble the data or to insert extra data bits that “levels out” the original data and creates a more favourable PAPR level. However, there are drawbacks to these solutions.

Typically, the known solutions are computational intensive, introduce delays, or introduce extra bits that decrease the data rate. There are no known algorithms how to recode or introduce “compensation-bits” and thus trial-and-error must be used.

The current standard for WLAN IEEE802.11 is about to gain success in being wide spread to customers with the purpose of replacing wired Ethernet LANs with wireless access. The current deployed standard 802.11b, is using the 2.4 GHZ unlicensed band. It is forecasted that if the current rate of deployment continues, the spectrum in the 2.4 GHz band will soon be insufficient and that a migration to 5 GHz and 802.11a will take place. The 802.11a specification uses OFDM signalling at the PHY (physical) layer. The OFDM modulated 802.11a PHY layer is sensitive to fluctuations in PAPR level.

Recently, a IEEE 802.16 Study Group on Mobile Broadband Wireless Access (MBWA) IEEE 802.16, has addressed radio access for stations in fast moving vehicles with speeds up to 200 mph. However, it is not possible to use the 802.11a physical (PHY) layer for mobile stations moving at a high speed and being exposed to adverse signalling conditions.

The MBWA requires pilot symbols evenly distributed—at a certain pilot-to-data ratio, PDR—throughout a packet in order for the frequency tracking and channel estimation mechanism to function for fast moving stations.

### SUMMARY OF THE INVENTION

It is a first object of the invention to set forth a method for decreasing the level of fluctuation of the PAPR level but without causing a data rate penalty.

This object has been achieved by the subject matter set forth by claim 1.

It is a further object to set forth a method of transmission that can easily be implemented in a transmitter, the method providing very low delay.

This object has been accomplished by the subject matter of claim 2.

It is a further object to set forth a method, which allows for a low PDR and thus a high throughput, but still providing a robust detection.

This object has been accomplished by the subject matter of claim 3.

It is a further object to set forth a transmitter providing robust data transmission and low PAPR values.

This object has been achieved by the subject matter of claim 9.

It is a further object to set forth a transmitter, which moreover is cost effective and provides low delay.

This object has been achieved by the subject matter of claim 10.

It is a further object to set forth a receiver allowing PAPR efficient transmission to be accomplished.

This object has been achieved by the subject matter of claim 12.

Further advantages will appear from the following detailed description of the invention.

### BRIEF DESCRIPTION OF THE DRAWINGS

FIG. 1 shows a typical transmitter,

FIG. 2 shows a typical receiver,

FIG. 3 shows an OFDM modulation scheme,

FIG. 4 discloses a transmitter according to a first embodiment of the invention,

FIG. 5 discloses a transmitter according to a second embodiment of the invention,

FIG. 6 discloses a receiver according to the first and second embodiment of the invention,

FIG. 7 shows pilot configurations according to a first embodiment of the invention,

FIG. 8 is a schematic illustration of the PAPR level for two alternative pilot configurations,

FIG. 9 shows a format for transmitted/received frames according to a first embodiment of the invention,

FIG. 10 relates to the calculation of pilot configurations according to the first embodiment of the invention,

FIG. 11 shows pilot configurations according to a second embodiment of the invention, and

FIG. 12 shows pilot configurations according to a further embodiment of the invention

### DESCRIPTION OF PREFERRED EMBODIMENTS OF THE INVENTION

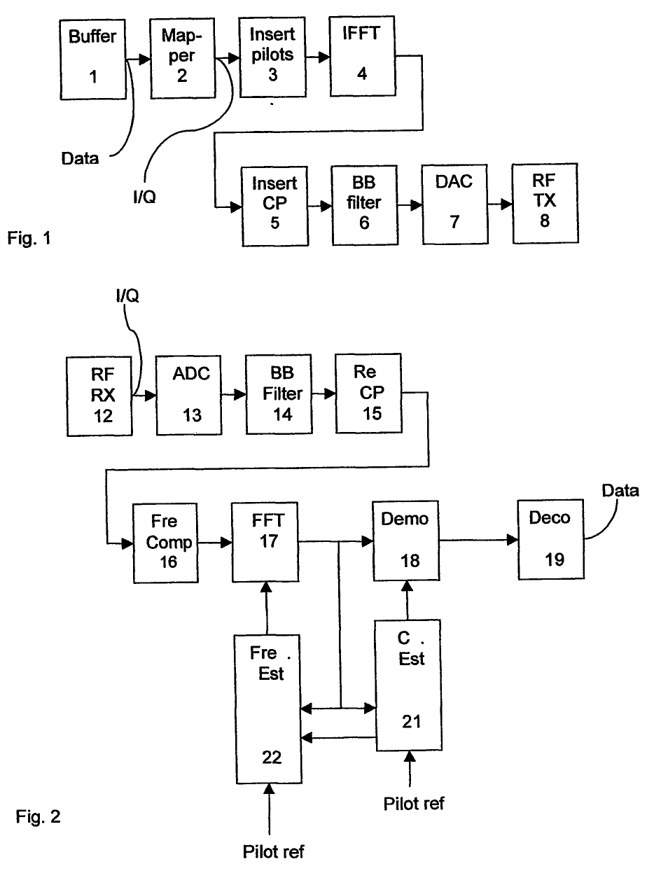

In FIG. 1, a conventional transmitter has been shown, comprising a buffer stage 1 for intermediately storing incoming payload data arranged in frames to be transmitted. The transmitter comprises a mapping stage (2) in which the payload data is mapped into complex symbols being defined by real, I, and complex, Q, components using for instance a BPSK or QAM modulation scheme. The transmitter moreover comprises a pilot insertion stage for interspersing appropriate pilot symbols in the stream of symbols carrying the payload data; an Inverse Fast Fourier Transform stage (IFFT) for mapping the BPSK or QAM modulated symbols onto respective sub-carriers and subsequently transforming the frequency domain signals to a time domain signal; a cyclic prefix (CP) insertion stage (5) providing a cyclic addition of the signal for facilitating suppression of multipath effects in the receiver stage; a baseband filter 6 for out-of-band suppression; a digital to analogue converter (DAC) (7); and a radio frequency transmit stage (RF TX) (8) for up-converting and amplifying the baseband signal to a high frequency transmit signal.

In FIG. 2, a conventional receiver has been shown comprising a receive amplification input stage RF RX 12 an analogue to digital conversion stage (ADC) 13 for converting the high frequency signal to a baseband signal; a baseband filter stage 14; a cyclic prefix removal stage 15; a frequency offset compensator 16 a Fast Fourier Transform stage 17 for transforming the baseband signal to frequency domain signals relating to the individual sub-channels. The receiver moreover comprises a demodulation stage 18 for decoding the information (BPSKI QAM) of the individual frequency domain signals back into bit estimates; using a channel estimation signal output from a channel estimator stage 21. Finally, a decoding stage 19 decodes the received signal into the original data frame format

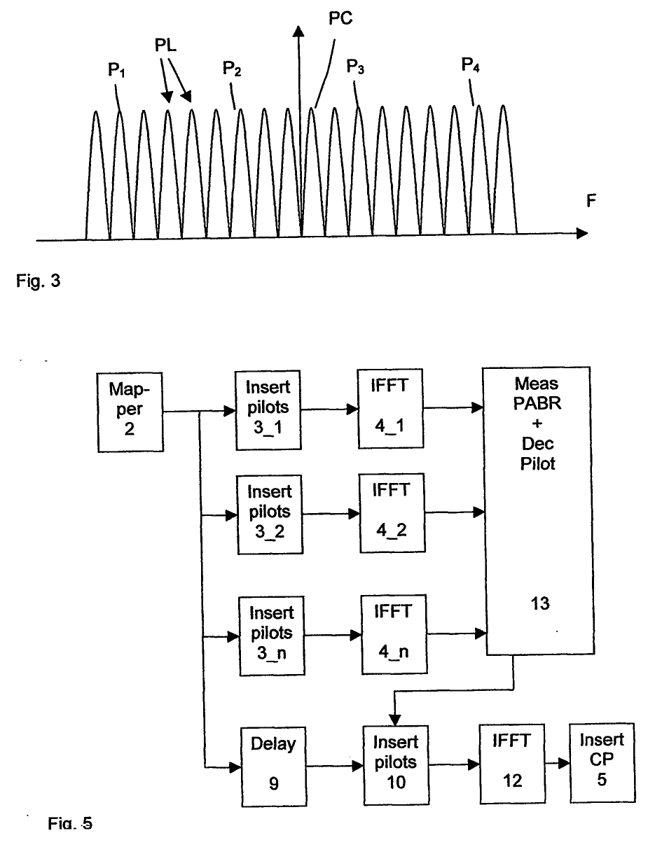

In FIG. 3, the frequency domain signal being output from the inverse fast Fourier transmission stage 4 of the conventional transmitter of FIG. 1 has been shown. As shown, the spectrum is divided into a plurality of orthogonal carrier channels, comprising a number of payload data channels PL and four pilot signals P1-P4. Similarly to the IEEE 802.11a standard, there may be 48 payload carrier channels and 4 pilot channels whereby the payload signals may be Quadrature Amplitude Modulated (QAM or any higher order of QAM modulation (n-QAM)) while the pilot signals may be binary phase shift keyed (BPSK).

### First Embodiment of Transmitter

In FIG. 4, a block diagram of the transmitter according to a first preferred embodiment of the invention has been shown. It should be understood that stages 6, 7 and 8 are the same as those shown with regard to FIG. 1. According to the invention—periods of data frames are intermittently split by splitter 21 into identical units 25 and 26.

Having regard to unit 25, the data is stored in buffer 10, wherefrom data is read out in a predetermined order into mapper 20 from which data is subsequently being provided in parallel to a plurality a pilot insertion stages 3_1, 3_2 . . . 3_{—}n.

In each respective pilot insertion stage, a predetermined configuration of pilot signals, PC, is applied to the various predetermined sub-carriers P1-P4. The configurations in each stage shall be different from one another. The individual pilot symbols, on the other hand, may be chosen arbitrarily as long as the configurations are unique. The payload data channels may be the same as shown in FIG. 3.

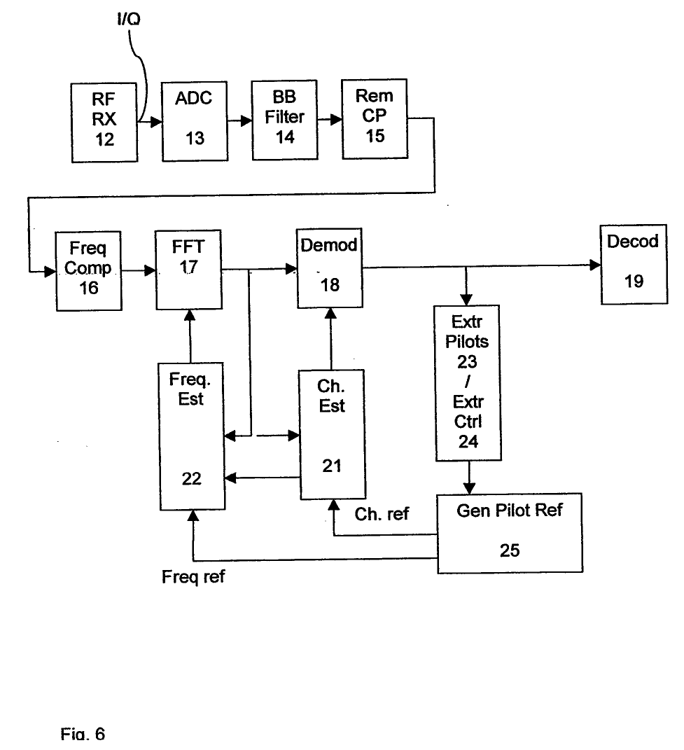

In FIG. 7, four exemplary BPSK pilot configurations being designated 00, 01, 10 and 11 have been shown for pilot channels P1-P4. Each pilot configuration is being inserted in a respective pilot insertion stage, such that stage 3_1 makes use of pilot configuration 00; stage 3_2 makes use of pilot configuration 01 and so forth. For instance in the configuration 00, the first pilot P1=−1, the second pilot P2=1; P3=1 and P4=−1.

As appears, each respective signal from the pilot insertion stage 3_1-3_{—}n is subsequently processed in respective control word insertion stages 5_1 to 5_{—}n, whose function shall be described later and to IFFT stages 4_1-4_{—}n such that respective frequency domain signals are provided.

The insertion of a given pilot configuration in the stream of payload data will give rise to a specific output signal from the respective Inverse Fast Fourier Transmission stage.

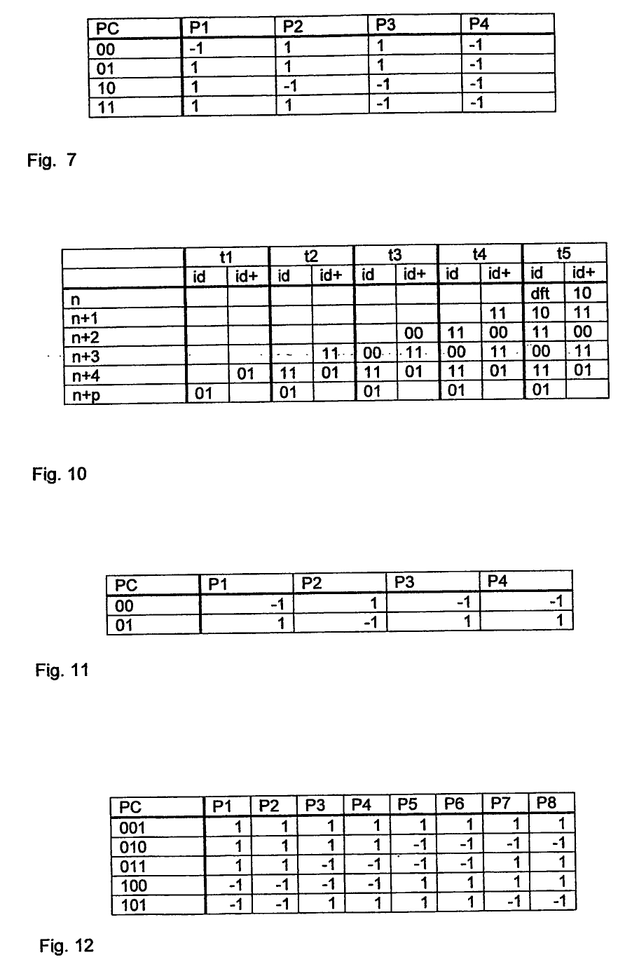

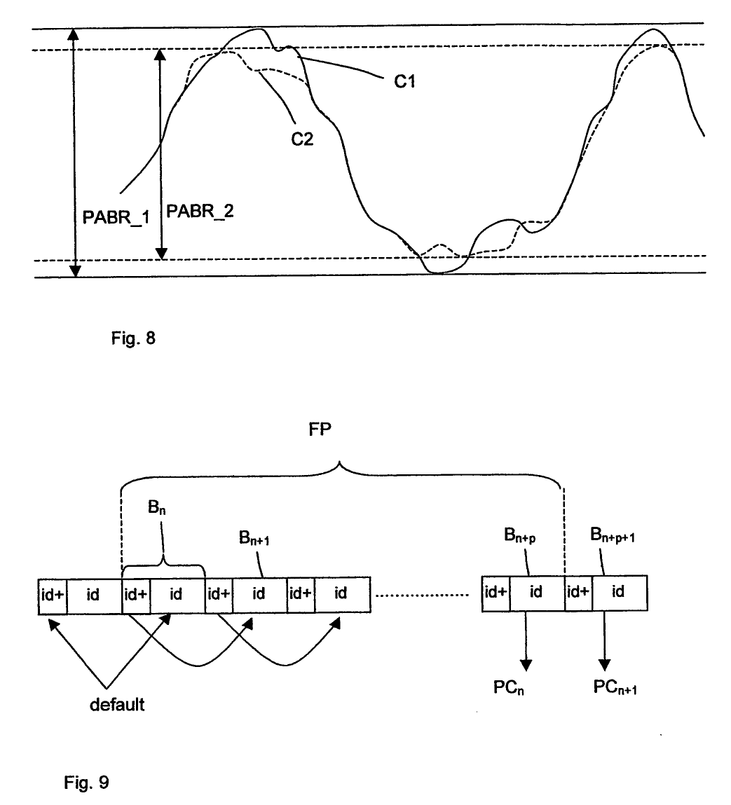

In FIG. 8, a first schematic output signal C1 corresponding e.g. to the configuration 01 being associated with a first PAPR value PAPR_1 and a second schematic output signal C2 corresponding e.g. to the configuration 10 being associated with a second PAPR value PAPR_2 have been illustrated.

As appears, the PAPR values differ because of the variations in the pilot configurations.

According to the present invention, the PAPR evaluation and pilot decision stage 13 carries out an evaluation of the PAPR values as provided by the respective IFFT stages 4_1-4_{—}n and chooses the pilot configuration, which is associated with the lowest value and stores results temporarily.

The idea here is that from a PAPR point of view it is advantageous to substitute fewer 20 sub-carriers more often in order to obtain a given pilot-to-data ratio (PDR). If there is more than one pilot configuration that can be chosen, it is possible to choose the configuration that minimises the PAPR. From the receivers point-of-view it is not important which pilot configuration is chosen, only that it is known.

Parallel to the pilot insertion stages 3_1-3-n, the delay stage 9 stores a predetermined number of payload data frames, each frame comprising the payload data, which is to be transferred over the payload channels.

Internally in the PAPR measurement and pilot decision device 13, the data frames comprising the id+ portion are intermediately stored. When all frames are processed as indicated at time t5 in FIG. 10, the chosen pilots and control words are inserted in frames to be transmitted in correct order in step 10 and step 11, respectively.

There are two methods to let the receiver know the specific bit pattern of the pilot configuration: Either specific information of which pilot configuration is to be used is signalled in advance by the transmitter or such information is derived directly from the pilot configuration by the receiver.

According to the first embodiment of the invention, information about the chosen pilot configuration is transmitted in advance. This information denoted control data is inserted on one predetermined payload channel, PL, in stage 11 and stages 5_1-5_{—}n of FIG. 4.

In FIG. 9, the frame format of received data has been shown for incoming frames Bₙ₋₁ to Bₙ₊ₚ₊₁. One part of the frame Id+, as coded on one of the data payload carriers, is a control word that indicates which pilot configuration, PC, will be used in a subsequent frame or in a frame of any predetermined subsequent order number.

By way of illustration, the other portion of the frame, PL, contain data, which has been coded according to a respective pilot configuration.

In FIG. 10, an exemplary illustration of a given stream of data frames has been shown. Stages 9, 10, 11 and 13 are performing calculations according to a certain frame period FP. In FIG. 10, the frame period is, by way of example, set to six frames. The processing of PAPR detection and evaluation in stage 13 is initially performed on frame Bn+5 (or Bn+p) at time t1. However, before the PAPR evaluation is carried out, a predetermined default pilot configuration is inserted as control word (id+). In the present example, the pilot configuration designated by 01 is inserted. Hence, a given pilot configuration is estimated for frame Bn+5. This information is coded as control word on the preceding frame Bn+4 via control word insertion stages 5_1-5_{—}n and 11. Since now one of the 25 payload channels are coded with a control word id+, the remaining payload data of frame Bn+4 must be PAPR evaluated with respect to the inserted control word. At time t2 this evaluation is carried out, and by way of example pilot configuration 11 is found to optimise PAPR value.

Hence, the transmitter processes the buffered frames in opposite order to the incoming frames. When frame Bn is reached at time t5, a default pilot configuration, dft, is used, such that synchronicity can be obtained for a subsequent frame period, FP.

It appears that every 6'th frame word will not be optimised with regard to PAPR. Hence, 35 a compromise will have to be made between processing delay and PAPR value as determined by the frame period.

Returning now to FIG. 4, the optimised pilot signal is inserted on a given frame B in stage 10, while in stage 11, the control word id+ as given by the evaluation unit 9 is inserted on one of the payload channels PL enabling subsequent detection.

As mentioned above, the other unit 26 carries out the same processes as described above on a subsequent period of frame and in this manner, units 25 and 26 work intermittently and secure that PAPR optimised frames are being transmitted. It is noted that the transmission involves a certain delay mainly depending on the frame period FP.

It is noted that many variations exist as to the number of frames being buffered or to which particular frame of a subsequent given order number the control word is associated.

### First Embodiment of Receiver

In FIG. 6, first and second embodiments of the receiver according to the invention have been shown. According to the first embodiment of the receiver according to the invention, which is meant for operation together with the transmitter according to the first embodiment, a control word extraction stage 23 is provided (According to a second embodiment of the receiver, the above control word extraction stage 24 is replaced with a pilot extraction stage 23).

The control word extraction stage 24 extracts the control word, id+, from the output of the demodulator 18. The pilot reference generator 25 transforms the pilot configuration information into the corresponding BPSK symbols for each pilot sub-carrier, e.g. according to the control information as set out in the table of FIG. 7.

From signals generated by the pilot reference generator above, a respective frequency reference signal, which is necessary for the frequency estimation stage 17 and a respective channel reference signal for the channel estimation stage 21, are provided, such that correct decoding can be performed at stage 19.

### Second Embodiment of Transmitter

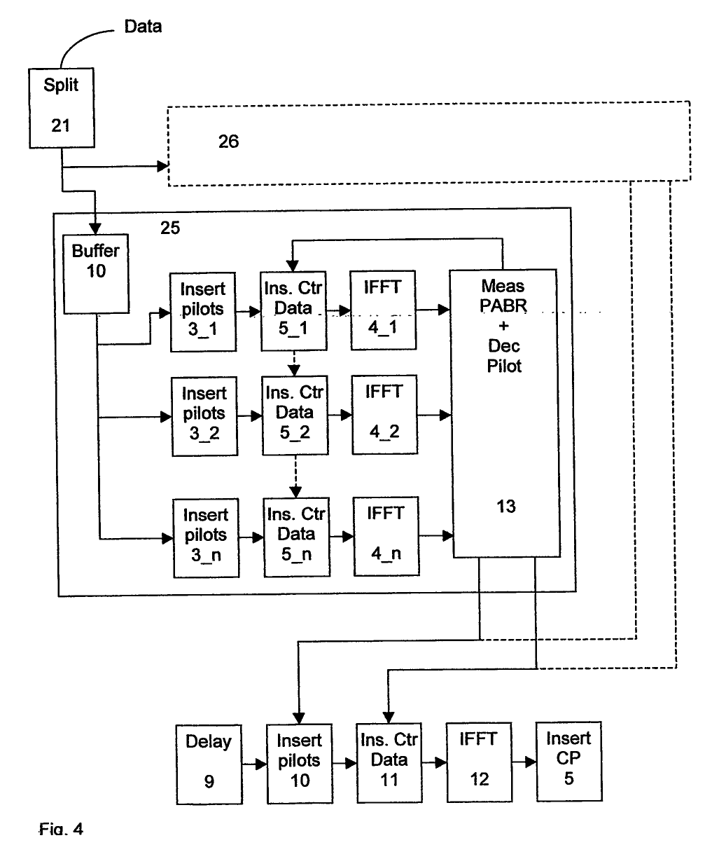

According to a further embodiment of the invention, the pilot configurations are formed as block codes, that is, codes, which even if exposed to a certain amount of changes to individual bits in the block or pilot configuration, will allow for correct interpretation. In FIG. 5, a transmitter for the second embodiment has been shown.

If the sub-set of allowed pilots to the set of possible pilots is sufficiently small, i.e. the Hamming distance between the pilots are large enough, the receiver can determine which pilot was transmitted even in the case that some bit errors should occur in the pilot configuration. In this way, there is no need to signal in advance which pilot symbol that is used.

As above, the transmitter calculates the PAPR for each of the pilot configurations and transmits the best one. If it is specified that only specific block codes are allowed for transmission, it is possible to determine in the receiver which code was transmitted even in the presence of errors. If more pilot sub-carriers are used per OFDM symbol, it is possible to use longer codes with better error correcting abilities.

FIG. 11 relates to the transmitter of FIG. 5 wherein only two pilot configurations are used, and hence only one out of two PAPR values can be chosen for optimisation. The code of FIG. 11 is a simple repetition code, which has an error correcting capability of 2.

The number of pilots can also be increased such that the error coding capability increases and the PAPR minimisation capability increases, although at the cost of an increased overhead. FIG. 12 is such an example in which the hamming distance of codes is larger or equal to 3.

It is noted that the transmitter according to the above embodiment corresponds largely to the transmitter shown in FIG. 4 except that the control word insertion stage 11 and the other means for various buffer operations (the processing shown in FIG. 10) are not provided.

Instead, incoming data is processed directly and fed in parallel to the pilot insertion stages 3_1-3_{—}n, such that the examination of PAPR values as explained with regard to the first embodiment of the transmitter can be carried out.

The delay stage 9 stores a predetermined number of payload data frames, each frame comprising the payload data that is to be transferred over the payload channels.

The delay is timed such that the choice of pilot configuration as indicated by PAPR measurement unit and pilot insertion unit 13 can be inserted on the actual frame on which the evaluation was performed. Hence, in stage 10 the chosen pilots are inserted.

It is noted that the transmitter is of a simpler construction than the first embodiment. Moreover, the delay in the transmitter has been considerably reduced.

Compared to the first embodiment of the transmitter, this method has a very low implementation cost. It is only necessary to process an extra IFFT for each code that is tested. For other methods, e.g. methods using re-scrambling, more processing is required. Moreover, all processing is performed on one OFDM symbol or frame at a time. There is no dependency between the OFDM symbols or frames and hence no need for synchronisation.

### Receiver—2'nd Embodiment

In FIG. 6, a second embodiment of the receiver according to the invention has been shown. Apart from the elements described above, the receiver comprises a pilot extraction stage 23. The pilot extraction stage extracts the assumed pilot configuration from the output of the demodulator 18. Furthermore, the pilot extraction stage 23 performs error correction of the received pilot configuration. The error corrected pilot configuration is forwarded to the pilot reference generator 25 for transformation into BPSK symbols.

### CONCLUSION

In conclusion, it is noted that the present invention improves PAPR performance in for instance OFDM modulated transmission systems. The present invention can be readily used, in order to allow data transmission for fast moving vehicles. The method proposed here shows how to choose the pilots in order to minimise the PAPR with no extra penalty, such as decrease in data rate. Having regard to wireless local area networks such as IEEE 802.11a the invention is apt as a modification to the physical layer (PHY) of such existing wireless LAN protocols. The present invention requires no modifications to the MAC (Media Access Control layer) signalling of such protocols.

It should be noted that the present invention is not limited for application to wireless LAN systems, but is applicable to systems in which a robust data transmission is desirable; hence, systems of which scope are defined in the appended claims.

1-13. (canceled)

14. A method of communicating consecutive frames of digital data, said method comprising the steps of:
mapping payload data into complex symbols;
interspersing appropriate pilot symbols; and,
mapping symbols on respective sub-channels;
whereby the insertion of a given pilot configuration into the stream of payload data will give rise to a specific output signal being associated with a given PAPR value;
wherein the digital data comprises OFDM modulated signals comprising a first plurality of payload carrying sub-channels and a second plurality of pilot carrying sub channels;
wherein each individual frame of payload data to be transmitted over the payload channels is associated with a given unique pilot configuration chosen from a sub-set of predetermined pilot configurations, each pilot configuration forming a unique pattern of predetermined pilot symbols and transmitted;
wherein, prior to the transmission of at least one given frame of payload data, each pilot configuration of the sub-set is evaluated with regard to PAPR for the associated frame of payload data, whereby the pilot configuration being associated with the lowest PAPR value is chosen for transmission.

15. The method according to claim 14, wherein the plurality of pilot configurations represent block codes allowing error correction at the receiver.

16. The method according to claim 14, wherein a control word indicative of the pilot configuration associated with a subsequent frame or a particular frame of a subsequent given order number is inserted into the frame and coded on a predetermined payload channel.

17. The method according to claim 16, wherein for every n-1 frame in a frame period, the complete frame comprising both payload data and the control word and pilot configuration is optimized with regard to PAPR.

18. The method according to claim 17, wherein every n frame in a frame period is not optimized with regard to PAPR.

19. The method according to claim 14, wherein, the sub-carriers carrying the pilot signals are digitally modulated at a lower order (BPSK) than sub-carriers carrying the payload data (QAM).

20. The method according to claim 15, wherein the block code forming pilot configurations have a hamming distance of ≧3.

21. The method according to claim 14, wherein the sub-channels are modulated by BPSK or n-QAM modulation.

22. A transmitter comprising:
a mapping stage, mapping payload data on a subset of a plurality of frequency orthogonal sub-carriers;
a plurality of parallel-coupled pilot insertion stages coupled to the mapping stage, each pilot insertion stage inserting a unique pilot configuration on at least another subset of sub-carriers;
a respective inverse fast Fourier transmission stage processing signals from each respective pilot insertion stage;
a PAPR measuring and pilot decision stage, measuring and evaluating PAPR for each unique pilot configuration;
wherein, each individual frame of payload data to be transmitted over the payload channels is associated with a given unique pilot configuration chosen from a sub-set of predetermined pilot configurations, each pilot configuration forming a unique pattern of predetermined pilot symbols, and transmitted; and,
wherein, prior to the transmission of at least one given frame of payload data, each pilot configuration of the sub-set is evaluated with regard to PAPR for the associated frame of payload data, whereby the pilot configuration associated with the lowest PAPR value is chosen for transmission.

23. The transmitter according to claim 22, wherein each unique pilot configuration has a hamming distance of at least three to any other pilot configuration.

24. The transmitter according to claim 22, further comprising a control word insertion stage for inserting a control word in a transmitted frame, the control word being indicative of the pilot configuration used in a frame of any given subsequent order number.

25. A receiver comprising:
a fast Fourier transform stage for transforming baseband signals into frequency signals relating to individual sub-channels; and,
a demodulation stage for performing individual demodulation, such as n-QAM, of the frequency signals into bit estimates;
wherein the receiver further comprises a pilot extraction stage for extracting block coded pilot signals into assumed pilot configurations;
wherein the assumed pilot configuration is provided to a frequency estimator for adjusting the fast Fourier transform stage and to a channel estimator for adjusting the demodulating stage.

26. A receiver comprising:
a fast Fourier transform stage for transforming baseband signals into to frequency signals relating to individual sub-channels; and,
a demodulation stage for performing individual demodulation, such as n-QAM, of the frequency signals into bit estimates;
wherein the receiver further comprises a control word extraction stage for extracting a control word of any subsequent order into an assumed pilot configuration; and,
wherein the assumed pilot configuration is provided to a frequency estimator for adjusting the fast Fourier transform stage and to a channel estimator for adjusting the demodulating stage.
